(19) United States
(12) Patent Application Publication
(10) Pub. No.: US 2013/0153290 A1
(43) Pub. Date: Jun. 20, 2013

(54) CABLE STRAIN RELIEF ELEMENT

(71) Applicants: Bernard Schlegel, Rahden (DE); Stefan Garske, Osnabrueck (DE); Martin Schmidt, Luebbecke (DE); Hartmut Schwettmann, Rahden (DE); Nicole Spilker, Luebbecke (DE)

(72) Inventors: Bernard Schlegel, Rahden (DE); Stefan Garske, Osnabrueck (DE); Martin Schmidt, Luebbecke (DE); Hartmut Schwettmann, Rahden (DE); Nicole Spilker, Luebbecke (DE)

(21) Appl. No.: 13/810,720

(22) PCT Filed: May 27, 2011
(86) PCT No.: PCT/DE2011/075122

§ 371 Date: Mar. 4, 2013

(30) Foreign Application Priority Data
Jul. 17, 2010 (DE) 102010027444.5
Jul. 17, 2010 (DE) 102010027445.3

(51) Int. Cl. H02G 15/184

(52) U.S. Cl. CPC H02G 15/184
USPC 174/653

(57) ABSTRACT

The invention relates to a cable screw connection (1, 100, 200, 300) for a plug-in connection housing, with a cable outlet socket (30, 120, 220) being formed at the housing body and with a tension relief element (40, 130, 230, 330) being provided, which mechanically stabilizes the cable to be connected as soon as a terminal screw head (2, 110, 210, 310) is screw connected, with the tension relief element (40, 130, 230, 330) can be fixated at a first end (40a, 130a, 230a, 330a) inside the cable screw connection (1, 100, 200, 300) in a torque-proof fashion, and with a second end (40b, 130b, 230b, 330b) of the tension relief element (40, 130, 230, 330) can be distorted in reference to the first end (40a, 130a, 230a, 330a) by a rotary motion of the screw head (2, 110, 210, 310).

This is a national stage of PCT/DE11/075122 filed May 27, 2011 and published in German, which has a priority of German no. 10 2010 027 445.3 filed Jul. 17, 2010, and German no. 10 2010 027 444.5 filed Jul. 17, 2010, hereby incorporated by reference.

The invention relates to a cable screw connection and/or cable fixation with an integrated cable tension relief for a plug-in connection housing according to the preamble of claim 1.

Cable screw connections generally also offer an integrated cable tension relief for a cable to be connected, here. Such cable tension relief and screw connections are required to hold cables at cable outlets of plug-in housings, switchboxes, or the like in a torque-proof and simultaneously tension protected fashion. The cable is mechanically stabilized by the cable tension relief.

### PRIOR ART

EP 0 627 588 B1 shows a cable screw connection for securing a cable at a cable outlet socket. The socket is provided with individual flexible clamping latches, which are guided against a seal pushed onto the cable jacket when a cap nut is screwed on and thus the seal and simultaneously the cable are clamped. When compressing the clamping latches it may occur that the compression applied via the seal upon the cable fails to reach the required strength in order to secure the cable against distortion and being pulled out.

### Objective

The objective of the invention comprises to suggest a cable fixation which ensures a reliable cable tension relief and simultaneously can be easily assembled.

The objective is attained in the characterizing feature of claim 1.

Advantageous embodiments of the invention are disclosed in the dependent claims.

The cable tension relief and screw connection suggested here for a plug-in connection housing essentially comprises a tension relief element and a screw head, with the tension relief element being fixed inside the cable outlet socket and the screw head fixed on said screw head.

Here, every end part for a cable screw connection and/or cable fixation is considered the screw head, which fixates the cable to be connected at the cable outlet. The screw head is not mandatorily provided with a thread.

The plug-in housing may be embodied in several parts. Generally the plug-in connection housing comprises two housing parts, a housing bottom and a housing top. The plug-in connection housing collects the contact elements connecting the cable to be fastened here. Generally the cable to be connected comprise multiple strands.

A so-called cable outlet socket is fastened at the housing body of the plug-in connection, through which the cable to be connected projects into the interior of the housing. The cable to be connected is encased by the screw head and simultaneously fixated thereat simultaneously when the screw head is screwed into the cable outlet socket.

When the cable outlet socket of the plug-in connection housing is provided with an internal thread, the screw head will be provided with a matching external thread and vice versa.

In order to ensure the functionality of the plug-in connection a tension relief is provided for the cable to be connected. A tension relief serves to protect the cable to be connected from mechanic stress (torque and tensile stress).

The tension relief element essentially shows a cylindrical shape. The first end of the tension relief element is provided with a circumferential external thread.

A second end of the tension relief element comprises fixation projections, which are formed thereat pointing towards the outside.

The internal wall of the cable outlet socket is provided with a thread. The circumferential thread of the first end of the tension relief element engages the thread of the cable outlet socket so that the tension relief element can be screwed into the cable outlet socket.

Ideally, the thread of the tension relief element is equivalent to the thread of the screw head such that the cable outlet socket only needs to be equipped with one internal thread. However, it is also possible to screw the tension relief element into the internal thread of the cable outlet socket and to fix the screw head via an external thread.

The tension relief element is screwed in up to a stop, which is located in the lower section of the cable outlet socket. The stop therefore limits the length of engagement of the tension relief element.

The fixation projections of the second end of the tension relief element engage the recesses of the screw head provided for this purpose. The screw head comprises a thread as well so that the screw head can be screwed via the internal thread of the cable outlet socket on said socket.

The tension relief element comprises a helical structure between its first end and its second end. When the tension relief element is screwed into the cable outlet socket up to the circumferential stop the first end of the tension relief element cannot be rotated any longer about the axis. When the screw head is screwed into the cable outlet socket the second end of the tension relief element is rotated about the axis in the direction of insertion, beyond the fixation projections engaging the recesses. The second end remains fixated, as already described above.

The helical structure is aligned such that any relative distortion of both ends of the tension relief elements in reference to each other, about the axis in the thread direction, leads to tension relief for the cable to be connected.

This occurs as follows: By the relative distortion of the second end of the tension relief element at its first ends, the helical structure between the two ends is constricted. The helical structure encases the jacket of the cable to be connected and thus forms the tension relief for said cable. The tension relief element stabilizes the cable to be connected and protects the contacts, which comprise the individual conductors of the cable in the plug-in connection, from mechanic stress. This way, the life of the plug-in connection—cable arrangement is considerably increased. The helical structure encasing the jacket of the cable represents a particularly long-lasting and reliable cable tension relief.

A sealing element is inserted in the screw head, which encases the jacket of the cable to be connected in a sealing fashion, and thus it protects the plug-in connection housing from media penetrating it, such as dust or water.

Advantageously the screw head shows a hexagon shape and can be screwed in via suitable hex wrenches into the cable outlet socket. This way, strong forces can be applied upon the screw head, allowing the cable tension relief also to compensate strong forces.

### EXEMPLARY EMBODIMENT

Several exemplary embodiments of the invention are shown in the drawings and are explained in the following. The features of the individual embodiments may be combined arbitrarily by one trained in the art, without here leaving the principle scope of the invention.

It shows:

### First Embodiment

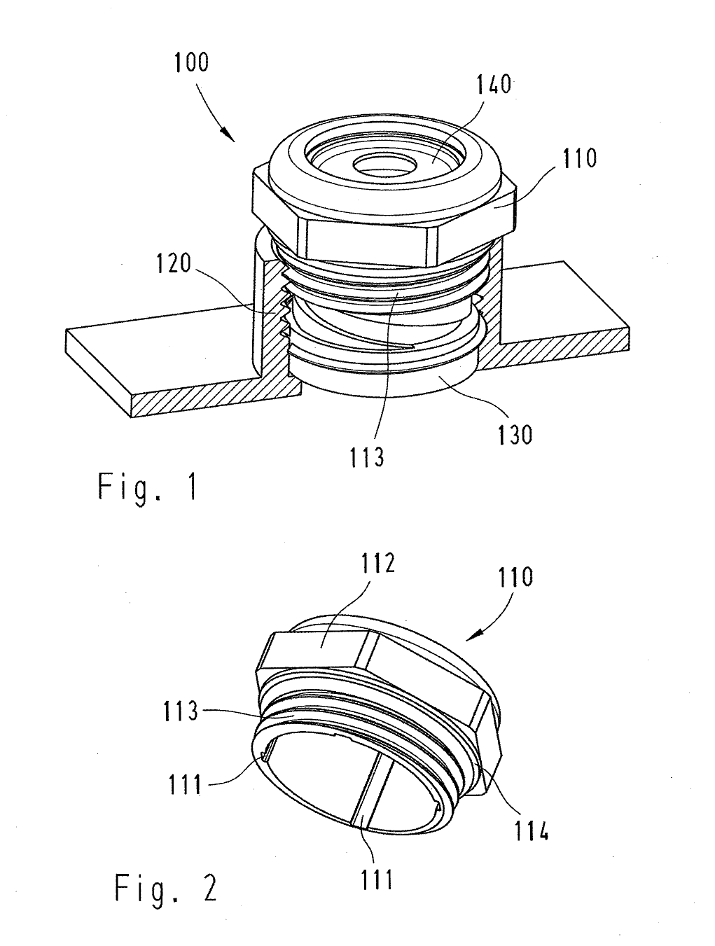

FIG. 1 a partially cross-sectioned, perspective illustration of the cable screw connection

FIG. 2 a perspective illustration of the screw head,

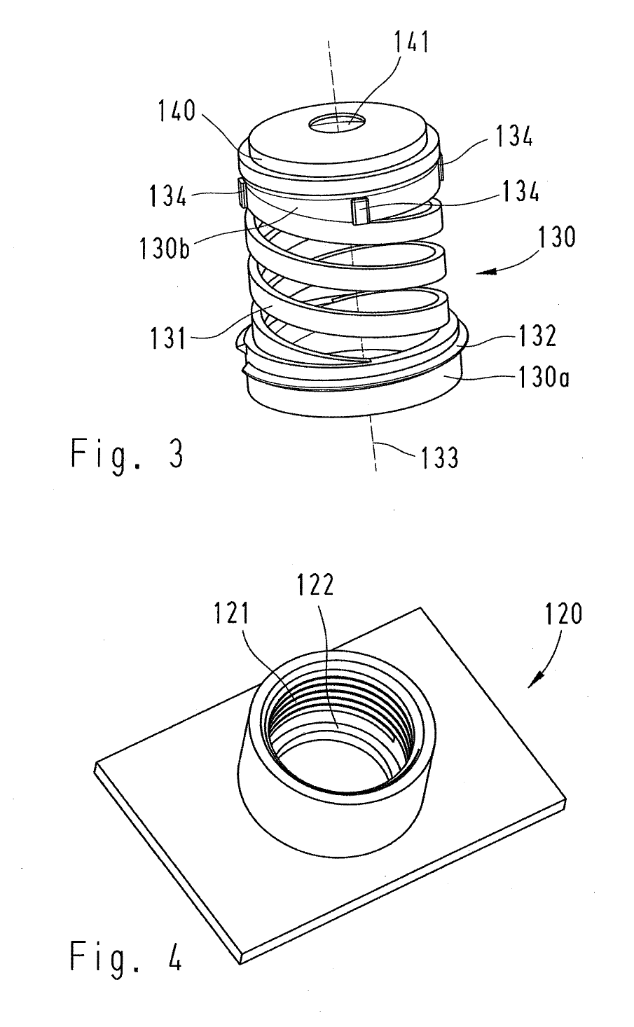

FIG. 3 a perspective illustration of the tension relief element comprising a sealing element,

FIG. 4 a perspective illustration of the cable outlet socket,

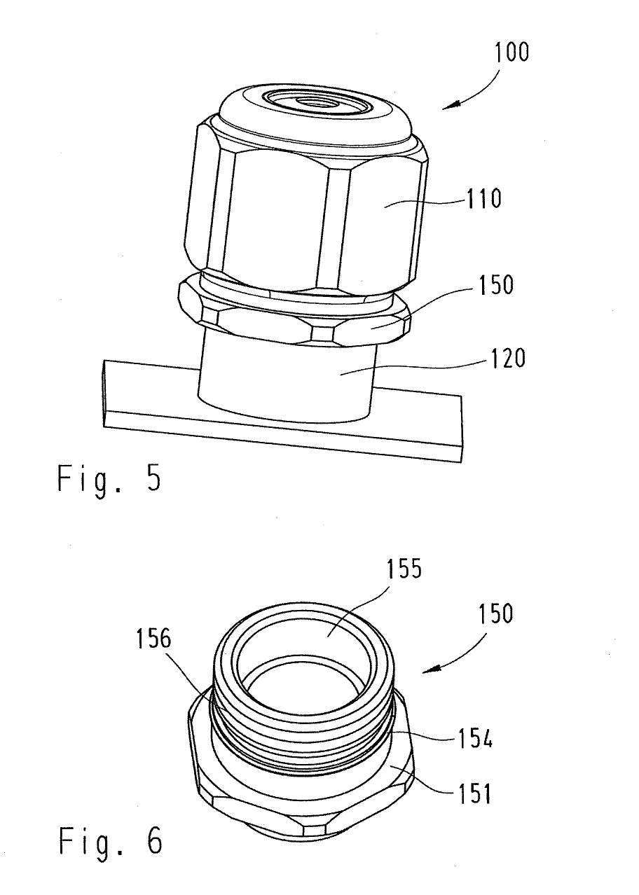

FIG. 5 a perspective view of another embodiment of the cable screw connection,

FIG. 6 a perspective illustration of an intermediate screw connection,

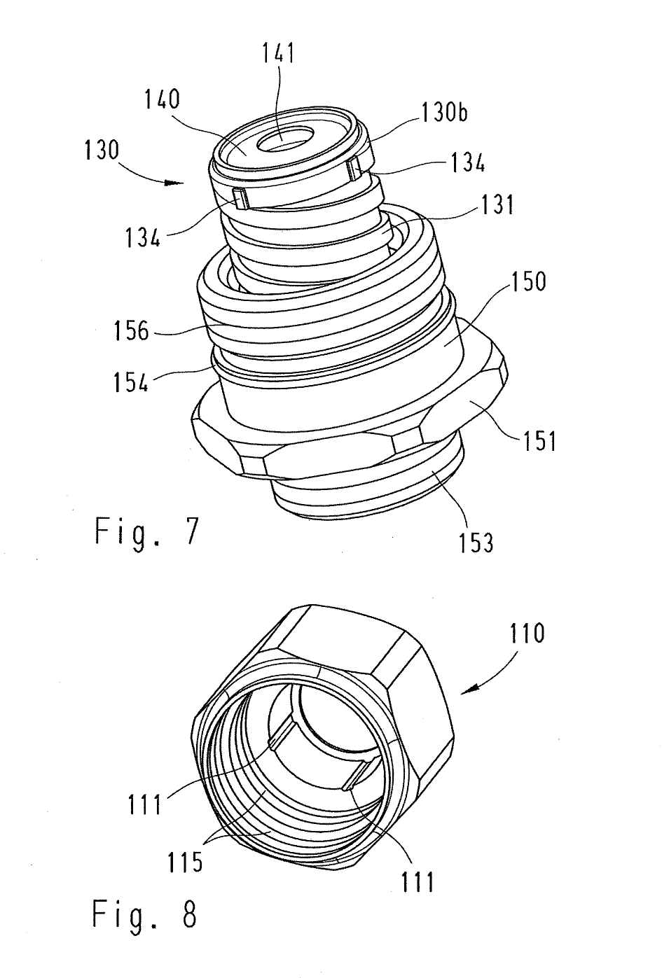

FIG. 7 a perspective illustration of the intermediate screw connection comprising a sealing element screwed in,

FIG. 8 a perspective illustration of the screw head of another embodiment,

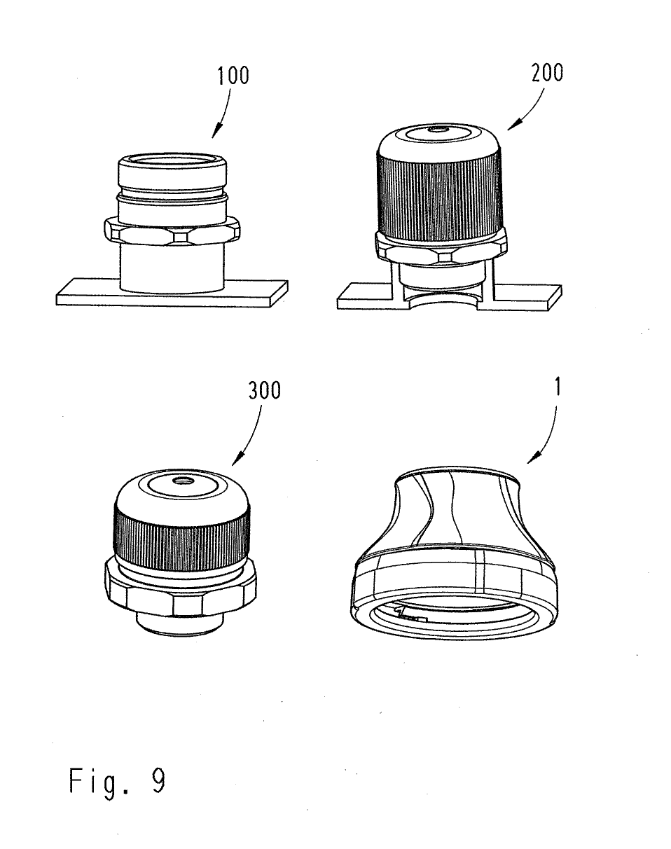

FIG. 9 an overview over various embodiments of a cable screw connection according to the invention,

### Second Embodiment

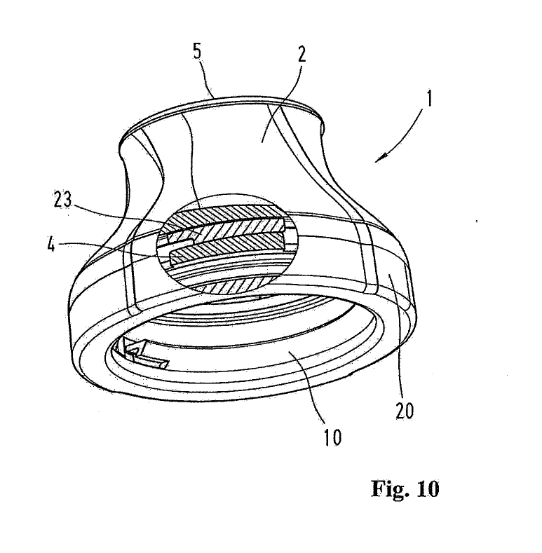

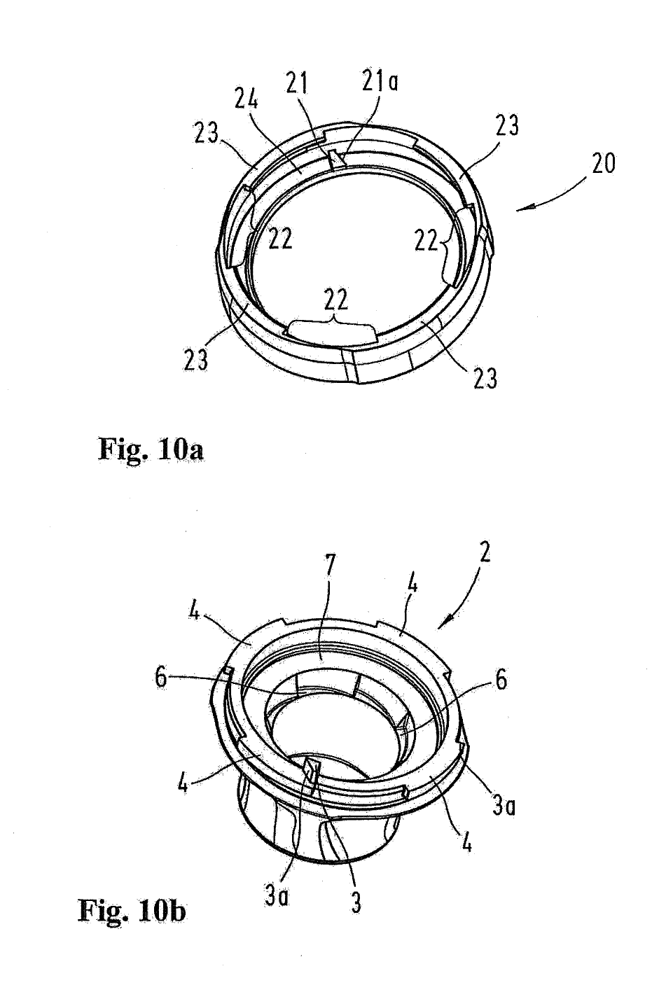

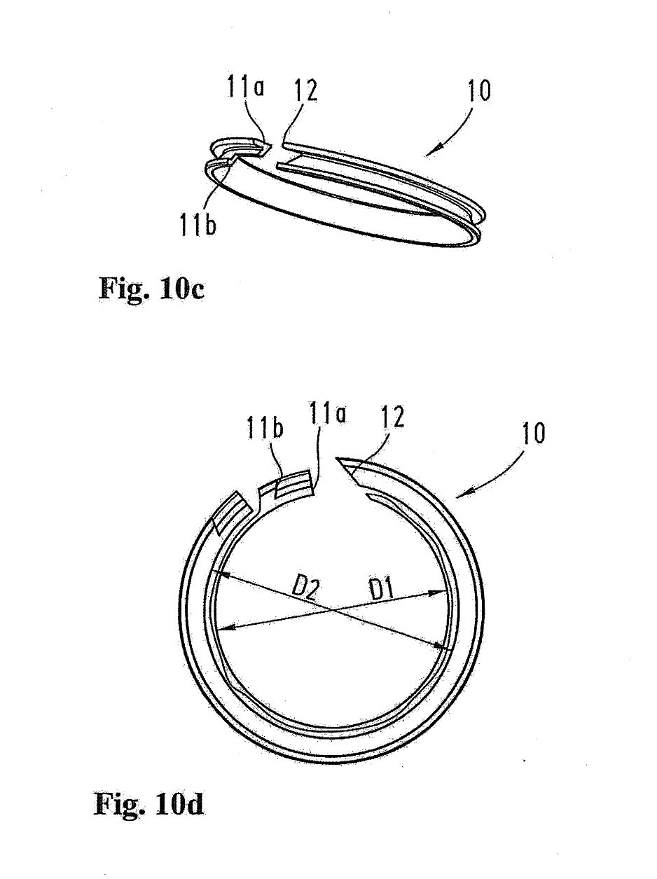

FIG. 10 a perspective illustration of a device for fixing the cable to a cable outlet socket,

FIG. 10a a perspective illustration of the locking rings,

FIG. 10b a perspective illustration of the clamping sheath,

FIG. 10c a perspective illustration of the spring element,

FIG. 10d a plane view of the spring element 10 with different diameters D1, D2,

FIG. 11 a perspective illustration of the cable outlet socket,

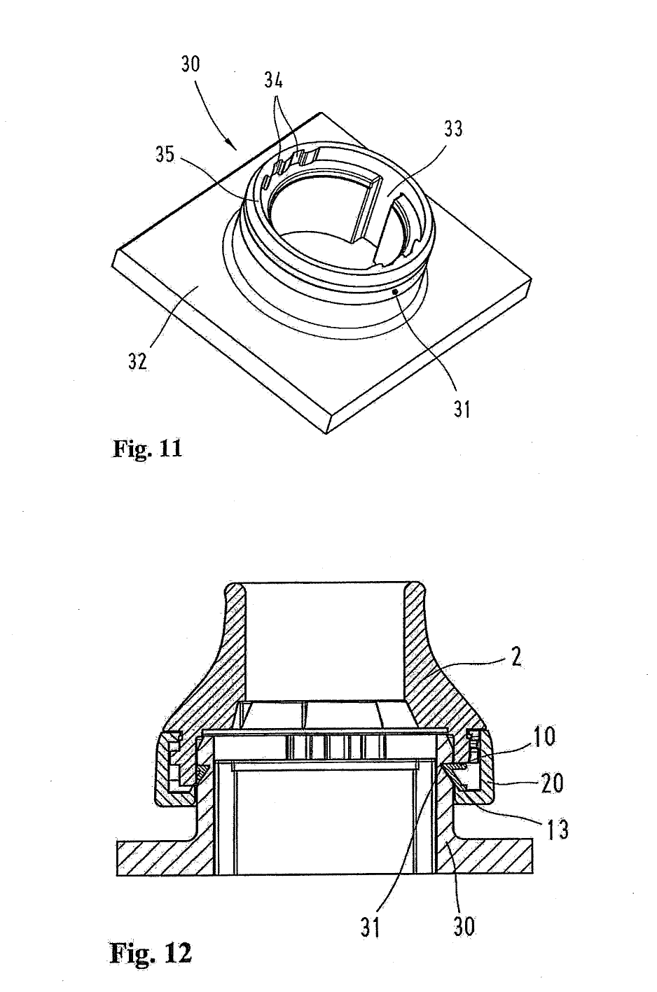

FIG. 12 a cross-sectional illustration of the device to fixate the cable on the cable outlet socket,

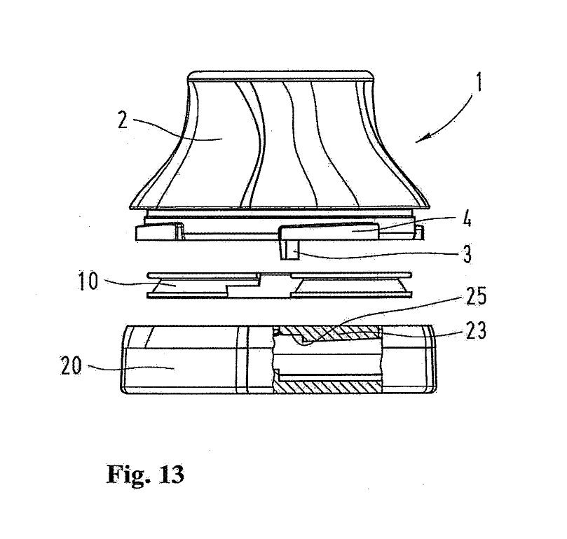

FIG. 13 an exploded drawing of the device to fixate the cable at the cable outlet socket,

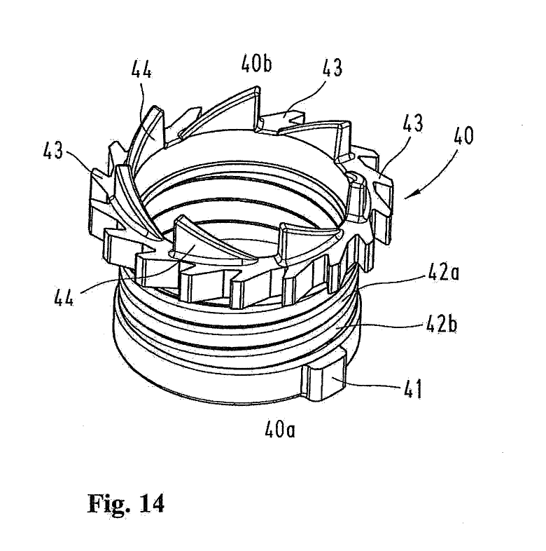

FIG. 14 a perspective illustration of the tension relief element in a double helix—embodiment,

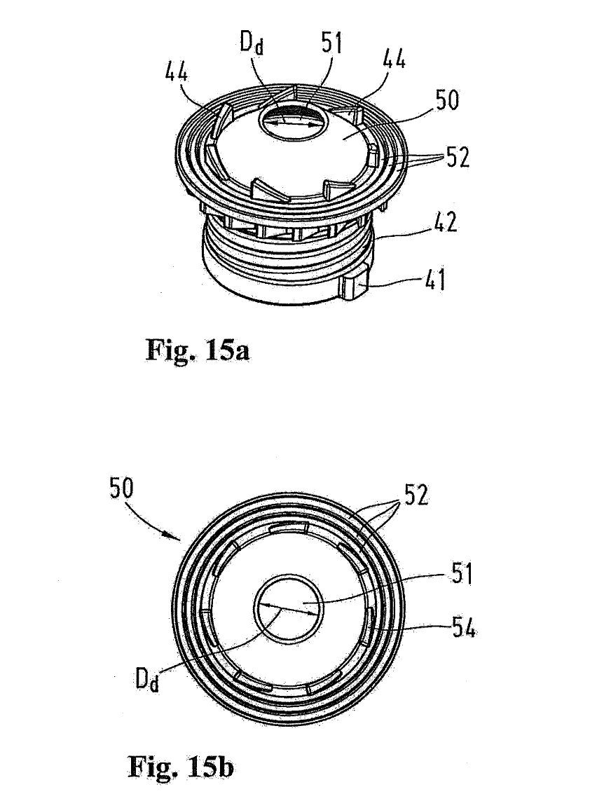

FIG. 15a a perspective illustration of the tension relief element with a sealing element connected thereto,

FIG. 15b a top view of the sealing element,

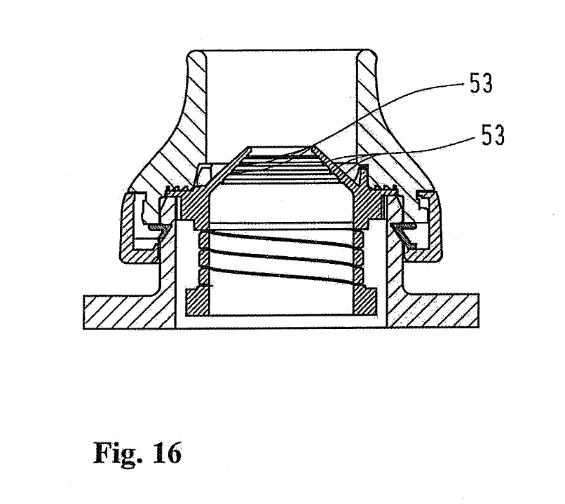

FIG. 16 a cross-sectioned illustration of the device for fixating the cable at a cable outlet socket with a cable tension relief,

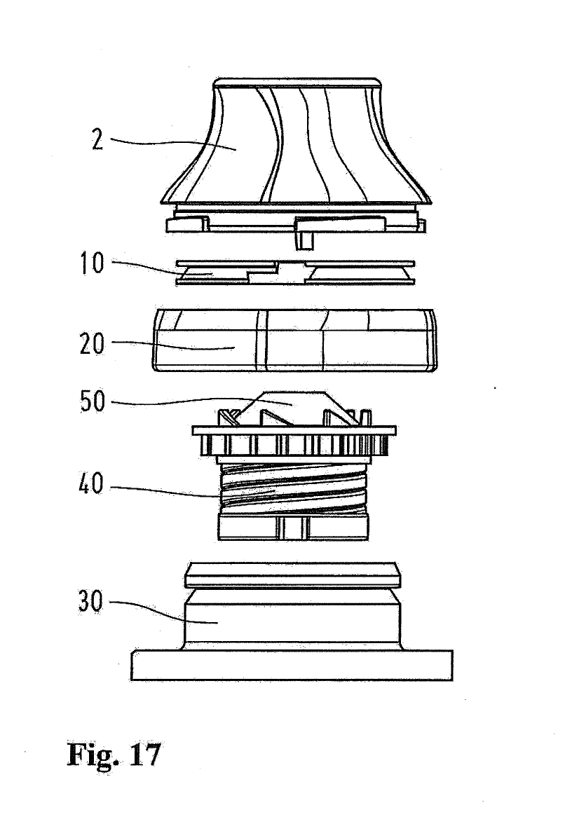

FIG. 17 an exploded drawing of the device for fixating the cable at a cable outlet socket with a cable tension relief,

### Third Embodiment

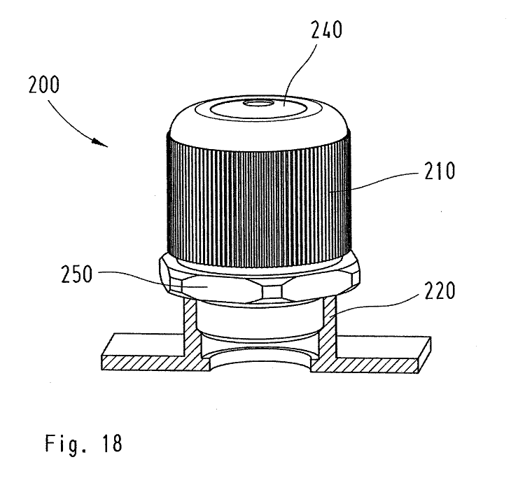

FIG. 18 a perspective illustration of another embodiment of the cable screw connection according to the invention,

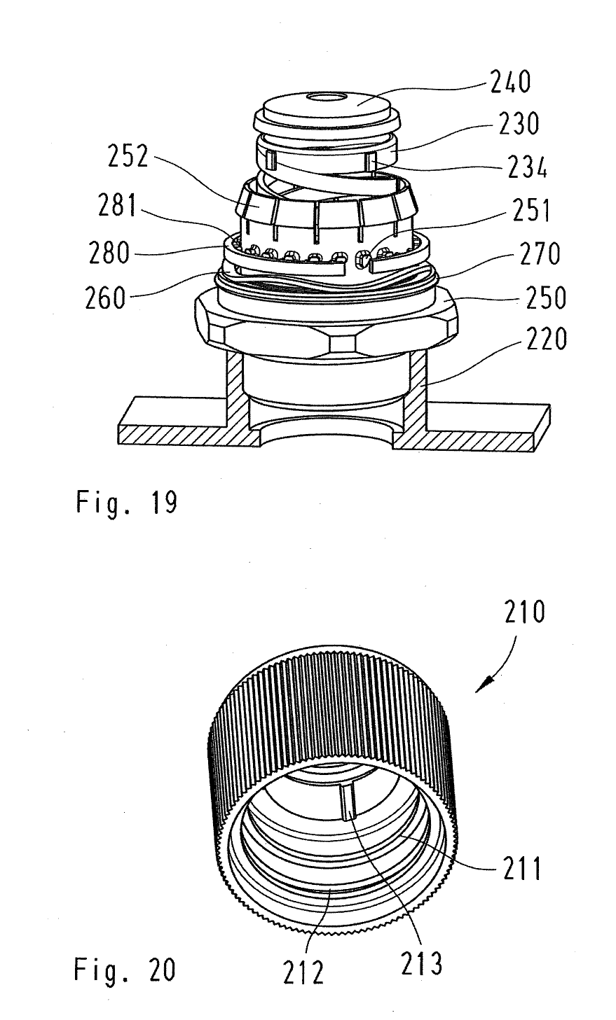

FIG. 19 a perspective illustration of the cable connection without the screw head,

FIG. 20 a perspective illustration of another screw head,

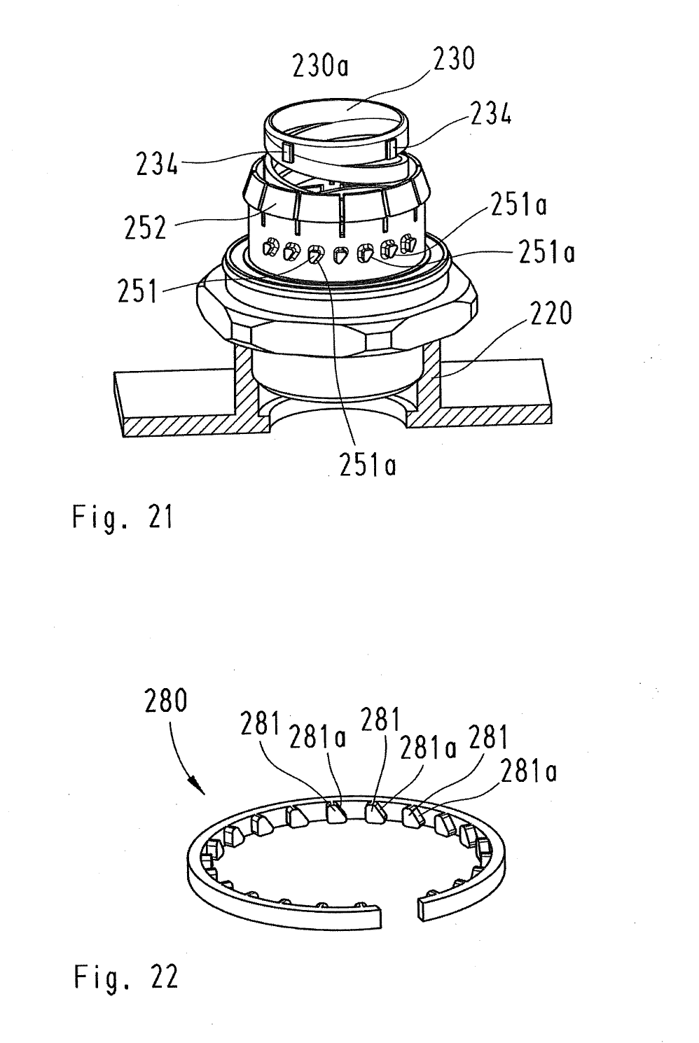

FIG. 21 a perspective illustration of another cable screw connection without a screw head,

FIG. 22 a perspective illustration of a latching ring,

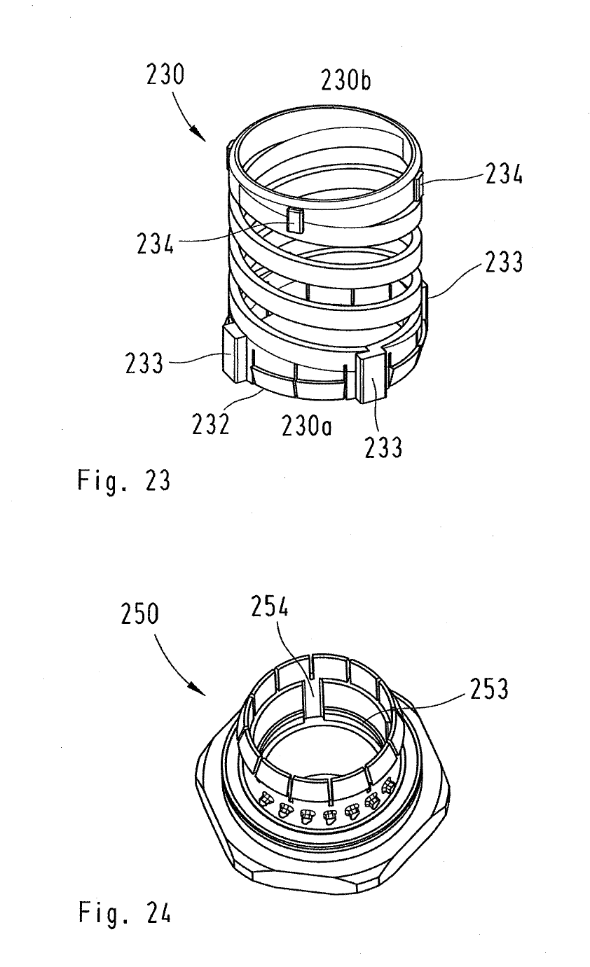

FIG. 23 a perspective view of another tension relief element,

FIG. 24 a perspective illustration of an intermediate screw connection,

### Fourth Embodiment

FIG. 25 a perspective illustration of another embodiment of a cable screw connection according to the invention,

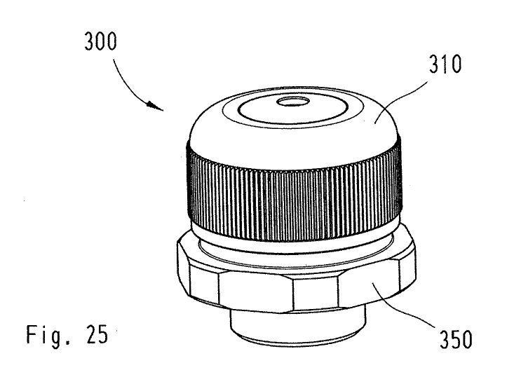

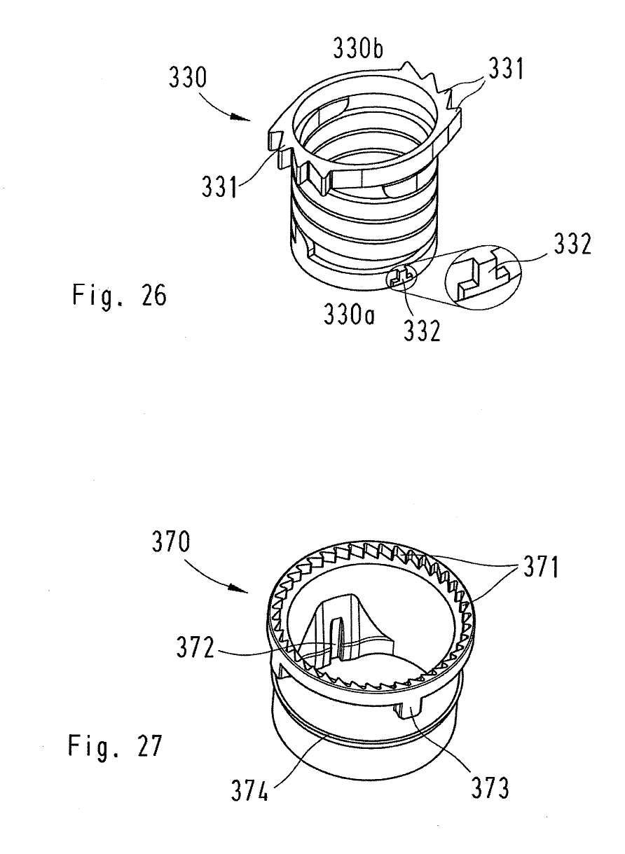

FIG. 26 a perspective illustration of a cable tension relief,

FIG. 27 a perspective illustration of a fixation sheath,

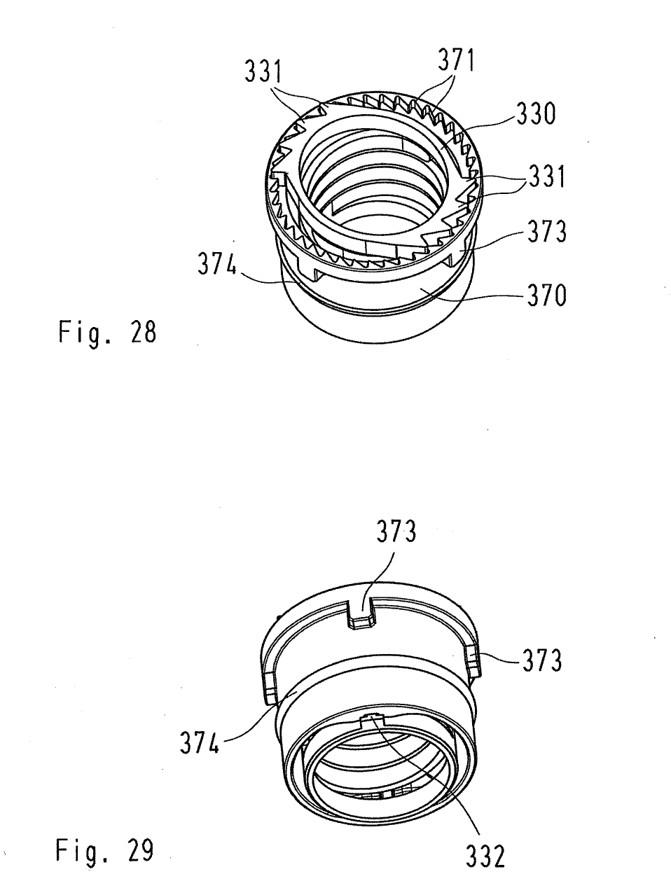

FIG. 28 a perspective illustration of a fixation sheath with an inserted tension relief element,

FIG. 29 another perspective illustration of a fixation sheath with an inserted tension relief element,

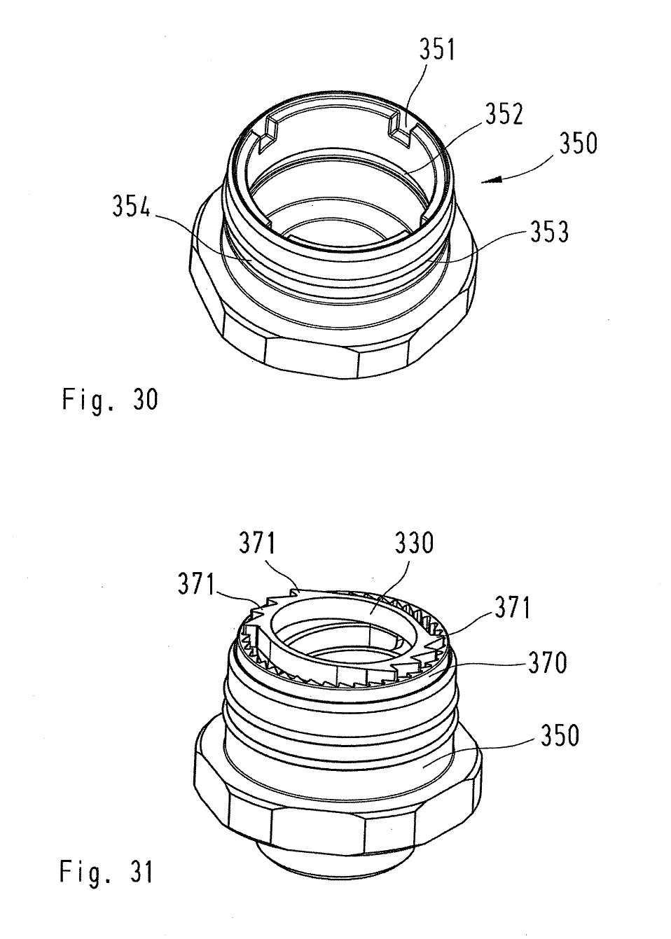

FIG. 30 a perspective illustration of an intermediate screw connection,

FIG. 31 a perspective illustration of an intermediate screw connection with an integrated fixation sheath and a tension relief element,

FIG. 32 a perspective illustration of a screw head,

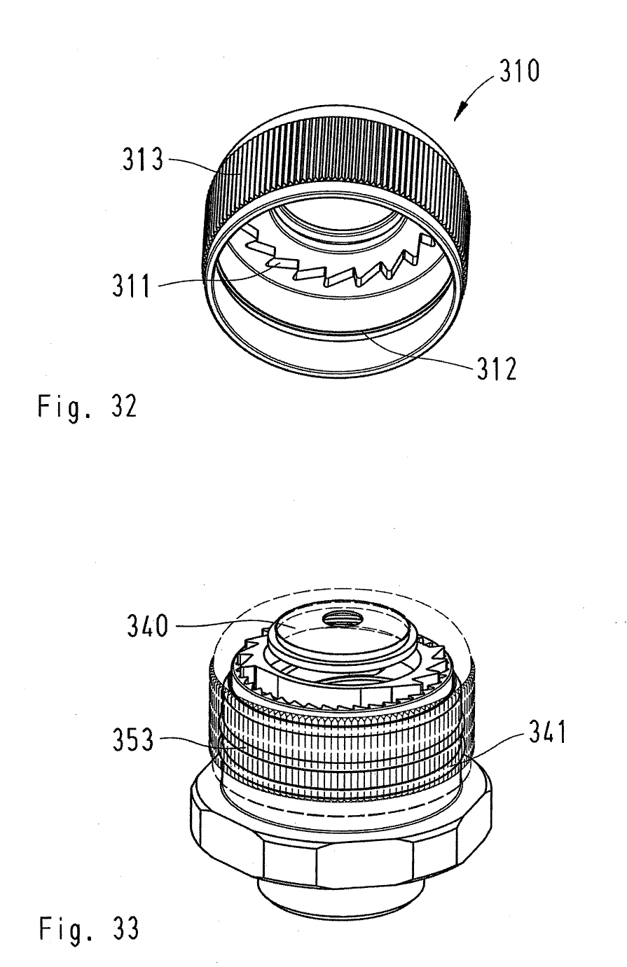

FIG. 33 a perspective illustration of the entire fourth embodiment with a transparent screw head.

FIG. 1 shows a partially cross-sectioned, perspective illustration of a cable screw connection. The cable screw connection 100 shown here comprises a tension relief element 130, a screw head 110, and a sealing element 140.

The tension relief element (FIG. 3) essentially comprises two annular ends 130a and 130b, which are connected to each other via a helical structure 131.

The first end 130a of the tension relief element 130 is provided with a circumferential thread 132, which can be screwed into an internal thread 121 of the cable outlet socket 120 (FIG. 4). The length of engagement of the tension relief element 130 is limited by a circumferential stop 122 in the cable outlet socket 120.

When the first end 130a of the tension relief element 130 reaches this stop 122, it cannot be rotated any further about the axis of symmetry 133. It is quasi fixated at one end.

The second end 130b of the tension relief element 130 comprises fixation projections 134. These fixation projections 134 engage recesses 111 of the screw head 110. By rotating the screw head 110 the second end 130b of the tension relief element 130 is moved in reference to the first end 130a. Hereby the helical structure is narrowed and thus fixates the cable jacket of the connected cable to the plug-in connection.

The helical structure is aligned such that it contracts in the direction of insertion around the cable jacket and fixates it. In the direction opposite of insertion the helical structure is loosened and the cable jacket is released.

The screw head 110 (FIG. 2) shows a hexagon section 112, so that it can be screwed into the cable outlet socket 120 using a common hex wrench. Here it is conditional that the thread 113 of the screw head 110 is compatible to the internal thread 121 of the cable outlet socket 120.

In FIG. 3 the sealing element 140 is directly connected to the tension relief element 130. Here, it represents separate components, though, embodied from different materials. The sealing element 140 is commonly produced from an elastomer (rubber, NBR, polyurethane, etc.) in order to ensure the sealing function. The tension relief element 130 may be made either from metal or from plastic, depending on the strength of mechanic forces acting upon the cable.

The opening 141 of the sealing element 140 shows a smaller diameter than the cable to be connected. This ensures that the seal tightly contacts the cable jacket and the plug-in connection housing is sealed against media such as dust and water. The screw head 110 is surrounded by a sealing ring 114 in order to achieve a good seal of the plug-in connection housing.

FIG. 6 shows another embodiment of the cable screw connection 100 according to the invention. It is also called full-depth screw connection. Identical features are marked with the same reference characters. In this full-depth screw connection additionally an intermediate screw connection 150 is provided, which connects the screw head 110 to the cable outlet socket 120.

FIG. 6 shows the perspective illustration of the intermediate screw connection 150. The intermediate screw connection 150 comprises a hexagon section 151, which allows to screw the intermediate screw connection 150 into the cable outlet socket 120 using a hex wrench. It is self-evident that here the thread 152 of the intermediate screw connection 150 must cooperate with the thread 121 of the cable outlet socket 120. A seal 154 is provided to seal the plug-in connection towards the outside against any media.

FIG. 6 also shows that the intermediate screw connection 150 comprises a stop 152, which limits the length of engagement of the tension relief element 130 into the intermediate screw connection 150. Here, this stop 152 performs the same function as the stop 122 of the cable outlet socket 20 in the first exemplary embodiment. The intermediate screw connection 50 is provided with an internal thread 155, which allows the above-mentioned screwing in of the tension relief element 130.

FIG. 7 shows the tension relief element 130 already screwed into the intermediate screw connection 150. A sealing element 140 is provided inside the tension relief element 130 comprising a cable opening 141. The intermediate screw connection 150 comprises an external thread 156, which cooperates with an internal thread 115 of the screw head 110 (FIG. 8). Similar to the first exemplary embodiment, the fixation projections 134 of the tension relief element 130 engage the internal recesses 111 of the screw head 110. During a tightening motion of the screw head 110 the two ends 130a, 130b of the tension relief element 130 are distorted in reference to each other, leading to the helical structure 131 to contract around the cable (not shown) to be connected and thus ensuring the cable tension relief.

In the following, another advantageous embodiment of a cable screw connection is described.

FIGS. 10a, 10b, and 10c show the individual components of the other embodiment of the cable screw connection. In this illustration the cable is not shown for reasons of clarity.

The fixation of the clamping sheath 2, surrounding the cable, on the cable outlet socket is described initially, independent from the fixation of the cable in the clamping sheath 2 itself. In a second part of the description the tension relief of the cable is discussed and the sealing of the cable fixation device against media such as dust and water.

The clamping sheath 2 (FIG. 10b) shows an essentially funnel-like shape. The clamping sheath 2 comprises a cable outlet opening 5 tapering towards the bottom. Oblong bars 4 are formed at the locking side, pointing radially outward. In the proximity of these rods 4 a support contour 3 extends in the axial direction. It shows essentially the shape of a triangle extruded into the space, a so-called triangular column with a lateral area 3a.

The locking ring 20 (FIG. 10a) is essentially embodied cylindrical. At one end the opening is constricted by a radially circumferential base ring 24. An entraining contour 21 is formed at the base ring 24. Geometrically the shape of the entraining contour 21 is essentially equivalent to the shape of the support contour 3 of the clamping sheath 2.

Oblong bars 23 are formed at the opposite end of the locking rings 20, which are separated from each other by recesses 22. The bars 4 of the clamping sheath 2 are inserted into the recesses 22 of the locking rings 20.

The spring element 10 (FIG. 10c) essentially shows the form of an open ring, with the spring element 10 being formed conically on the inside. One end of the spring element 10 is embodied in two steps 11a, 11b. The ends 11b, 12 of the spring element 10 are stretched between the area 3a of the support contour 3 of the clamping sheath 2 and the area 21a of the entraining contour 21 of the locking ring 20.

The distance of the entraining contour 21 from the support contour 3 changes by a relative motion of the locking ring 20 in reference to the clamping sheath 2. This way, the spring element 10 is widened, so that the diameter D changes, depending on the direction of rotation of the locking ring 20. When rotating the locking ring 20 clockwise (locking direction) up to the end position here the diameter of the spring element 10 becomes minimal D1. Simultaneously the bars 4 and 23 are pushed over top of each other and clamp the clamping sheath 2 to the locking ring 20 according to the bayonet principle. In an opposite rotation (opening direction) of the locking ring 20 the diameter of the spring element 10 becomes maximal D2 and the bars 4 and 23 are no longer located over top of each other so that the clamping sheath 2 can be separated from the locking ring 20.

The cable outlet socket 30 (FIG. 11) is essentially embodied cylindrical and generally formed at a plug-in connection housing (not shown here). A parallel, circumferential groove 31 is inserted into the jacket of the cable outlet socket 30, parallel in reference to the base area 32.

Similarly, the locking ring 20 encases the clamping sheath 2 and the cable outlet socket 30 (FIG. 12). When rotating the locking ring 20 into the end position of the locking direction the conically shaped interior of the spring element 10 engages the circumferential groove 31 of the cable outlet socket 30 in a form-fitting fashion. This way, a clamping sheath 2 is fixated on the cable outlet socket 30.

When entering the circumferential groove 31 the conical shape of the inside of the spring element 10 causes the clamping sheath 2 to be pulled slightly downwards, in the direction of the cable outlet socket. The spring element 10 comprises at the outside an edge 13 serving to center the spring element 10 in the locking ring 20.

FIG. 13 shows an exploded illustration of the elements clamping sheath, spring element, and locking ring, which in the above-described interaction are suitable for fixating the clamping sheath on the cable outlet socket. The locking ring 20 is here shown in a partially cross-sectioned fashion. This discloses the contour 25, which fixates and/or supports the spring element 10.

As already stated above, now the tension relief of the cable and the sealing of the cable fixation device against media, such as dust and water, is discussed.

The tension relief element 40 (FIG. 14) essentially comprises terminal rings, which are connected to each other by a helical and/or screw-like structure 42. FIG. 14 shows a tension relief element 40 with a double helix structure. This means, that between the ends 40a, 40b simultaneously a clockwise and a counter-clockwise structure are provided. This leads to a better centering of the cable in the tension relief element 40.

Contours 41 are provided at the first end 40a of the tension relief element 40, pointing radially outward, which can be inserted into matching recesses 33 of the cable outlet socket 30. This way, the first end 40a of the tension relief element 40 is fixed in a torque-proof fashion in the cable outlet socket 30.

At the second end 40b the tension relief element 40 comprises latching hooks 43 pointing radially outward.

They latch with latching contours 34 in the upper part of the cable outlet socket 30 so that even the end 40b is fixed in a torque-proof fashion.

Furthermore, at the second end 40b the tension relief element 40 comprises entraining hooks 44, pointing axially upward, which cooperate with the entraining contours 6 of the clamping sheath 2. The entraining sheaths 44 essentially show the form of a saw tooth. By a rotation of the clamping sheath (in reference to the cable outlet socket) in the direction towards the declining flank of the entraining hooks 44 the second end 40b of the tension relief element 40 is moved in reference to the first end 40a and the helical structure is constricted between the ends 40a, 40b. Any cable guided therebetween is clamped and this way tension relief is realized for the cable.

However, in case of any rotation of the clamping sheath 2 against the declining flank of the entraining hooks 44 the entraining hooks 44 glide down the entraining contours 6 of the clamping sheath 2. The ends 40a, 40b are not moved in reference to each other.

During a back and forth movement of the clamping sheath 2 the helical or screw-like structure, similar to a ratchet, can be tightened around the cable jacket of the cable to be connected, here. No additional tool is required.

The second end 40b of the tension relief element 40 is connected to the sealing element 50 (FIGS. 15a, 15b). Here, the entraining hooks 44 penetrate recesses 54. The cable to be connected is guided through the opening 51 of the sealing element 50. The diameter Dd of this opening is respectively smaller than the diameter of the cable to be connected.

At the exterior, the sealing element 50 comprises pressure lamellae 52. They ensure sufficient compression of the sealing upon the cable outlet socket 30.

The clamping sheath 2 partially encases the jacket surface of the cable outlet socket 30. A circumferential edge 7 is formed inside the clamping sheath 2. In the assembled state of the device 1, the sealing element 50 is arranged between this edge 7 and the brim 35 of the cable outlet socket 30 (FIG. 16).

The internal sealing lamellae 53 along the opening 51 reinforce the material thickness of the elastomer and thus increase the compression (effective sealing) towards the cable jacket.

FIG. 16 shows all components of the device cooperating for fixation, sealing, and tension relief of a cable to be connected to the cable outlet socket of a plug-in connection, switchbox, or the like.

FIG. 17 shows an exploded drawing of the components of FIG. 16.

In the following, another advantageous embodiment of a cable screw-connection is described.

FIG. 18 shows a perspective illustration of another embodiment of the cable screw-connection 200 according to the invention.

The screw head 210 is provided with a lamellae structure at its exterior in order to ensure the grip of the screw head 210 when tightening.

FIG. 19 shows the cable screw-connection 200 without any screw head 210. The intermediate screw-connection 250 is provided with latching springs 252, which serve to fixate the screw head 210 by engaging the latching springs 252 behind a circumferential bar 211, which is located inside the screw head 210 (FIG. 20).

The intermediate screw connection 250 additionally comprises latching contours 251, which cooperate with identically named latching contours 281 of a latching ring 281 during the process of generating a screw connection. The latching ring 281 is inserted into a circumferential groove 212 inside the screw head 210 in a non-displaceable manner. Alternatively the latching contours 281 can also be formed directly inside and at the screw head 210. The effective interaction of the latch contours 251 and 281 is explained in greater detail in the following.

The intermediate screw connection 250 is surrounded by an annular sinuous spring 260. The annular sinuous spring 260 permanently presses the screw head 210 upwards so that the diagonal areas 251a and 281a of the latching contours 251 and 281 are aligned towards each other.

FIG. 23 shows the perspective view of the tension relief element 230 of this embodiment. The tension relief element 230 is embodied with two ends, with a helical structure being provided between the ends 230a, 230b.

The first end 230a is provided with latching springs 232, engaging behind a circumferential bar 253 located inside the intermediate screw connection 250 so that the tension relief element 230 is fixed in the intermediate screw connection 250 such that it cannot get lost.

Additionally, at the first end 230a of the tension relief element 230, fixating projections 233 are provided engaging the recesses 254 located inside the intermediate screw connection 250. This way, the first end of the tension relief element 230 is fixated in the intermediate screw connection 250 in a torque-proof fashion. The fixating projections 234 of the second end 230a engage recesses 213 of the screw head 210.

By a rotary motion of the screw head 210 in the clockwise direction the second end 230b is distorted in reference to the first end 230a. This way, the helical structure is tightened between the ends 230a, 230b about the cable jacket of the cable to be connected, here. This principle has already been described repeatedly.

During the clockwise rotation of the screw head 210 the diagonal areas 251a and 281a of the intermediate screw connection 250 and/or the latching ring 280 glide along each other so that the screw head 250 is respectively briefly moved gradually downwards. The annular sinuous spring 260 constantly counteracts the downward motion. When the cable jacket of the cable to be connected is tightly clamped by the tension relief element 230 the screw head 250 is pressed back into its original position. In the original position the latching contours 251, 281 prevent any inverse rotary motion (counter-clockwise) of the screw head 250.

The relaxation of the cable to be connected can be achieved by rotating the screw head 250 counter-clockwise. However, first the screw head must be pressed down, here, in order to prevent the latching contours 251 and 281 from blocking the rotary motion.

In the following, another advantageous embodiment of a cable screw connection is described.

FIG. 25 shows a perspective illustration of this additional advantageous embodiment.

In this embodiment, similar to the embodiment according to the reference character 200, an intermediate screw connection 350 is used, which can be screwed upon a cable outlet socket.

FIG. 26 shows the tension relief element 330 of this embodiment, which is realized with two ends 330a, 330b. The tension relief element 330 is embodied helically between the ends 330a, 330b. The second end 330b of the tension relief element 330 is embodied elliptically.

A fixation sheath 370 (FIG. 27) is clamped into the intermediate screw connection 350 (FIG. 30). This way, the fixation sheath 370 is inserted into the intermediate screw connection in a torque-proof fashion, comprises the contours 373, which are located in recesses 351 of the intermediate screw connection 350. In order to fixate the fixation sheath 370 in the axial direction it additionally comprises the circumferential contour 374, which engages a circumferential groove 352, provided for this purpose in the intermediate screw connection 350.

The tension relief element 330 comprises contours 332 at its first end 330a, which engage recesses 372 of the fixation sheath 370. This way the tension relief element 330 is fixated at this end 330a in the fixation sheath 370 in a torque-proof fashion, and via the fixation sheath 370 also in the intermediate screw connection 350. The intermediate screw connection and the fixation sheath can also be connected to each other, i.e. embodied in one piece.

FIGS. 28, 29 show the tension relief element 330 inserted into the fixation sheath 370. The tension relief element 330 comprises latching hooks 331 at its second end 330b, which engage in latching contours 371 of the fixation sheath 370. The latching hooks 331 project in the radial direction beyond the latching contours 371. The importance of this feature is explained in the following.

FIG. 32 shows a screw head 310 (also called extension element), which comprises at its inside clamping teeth 311, which point downwards in the radial direction. The clamping teeth 311 engage the part of the latching hook 331 of the tension relief elements 330 projecting beyond the latching contours 371.

By rotating the screw head 310 in the clockwise direction (tightening direction) the latching hooks 331 of the tension relief element 330 glide over the latching contours 371 of the fixation sheath 370. The materials of the tension relief element 330 and the fixation sheath are selected appropriately.

In the tightening direction the diagonal flanks of the latching hooks 331 and the latching contours 371 contact. This way the latching hooks are pressed radially inwardly and the elliptic form of the second end 330b becomes a circular one. The latching contours 371 or the fixation sheath 370 are here formed such (embodied longer in the radial direction) that the latching hooks 331, even in case of the circular form of the second end 330b, continue engaging the latching contours 371. The latching contours are formed such that any inverse rotation (counter-clockwise) of the tension relief element is not possible without applying force.

In the tightening direction the two ends 330a, 330b of the tension relief element are distorted in reference to each other, causing the helical form to constrict between the ends, and this way fixating the cable jacket of a cable to be connected, here.

This basic principle has already been described repeatedly.

When rotating the screw head 311 counter-clockwise (loosening direction) the diagonal flanks of the clamping teeth 311 contact the diagonal flanks of the latching hooks 311 of the tension relief element 330. Simultaneously the steep flanks of the latching hooks 331 and the latching contours 371 contact.

The diagonal flanks of the clamping teeth 311 apply a force upon the diagonal flanks of the latching hook 331, causing the area of the second end 330b of the tension release element 330, comprising the latching hooks, to be deflected radially inwardly. This occurs until the latching hooks 331 engage the latching contours 371. Then the second end 330b of the tension relief element 330 can be rotated counter-clockwise in reference to the first end 330a, leading the cable jacket of the cable to be connected to leave the range of influence of the helical form.

FIG. 33 shows the fourth embodiment of the cable screw connection in the assembled state. The screw head 310 is provided at its exterior with a lamella structure, in order to ensure a good grip of the screw head 310 during the tightening process.

The screw head 310 is shown transparent in FIG. 33, allowing the function of the underlying components to be discernible. Additionally, the sealing element 340 are visible at the cable side and the sealing element 341 at the side of the screw connection. The sealing elements 340, 341 seal the cable screw connection against media, such as dust and water.

List of reference characters
Helical cable tension relief

| | | | |
|---|---|---|---|
| 1 | Cable screw connection | | |
| 2 | Clamping sheath | 40 | Tension relief element |
| 3 | Support contour | 41 | Contour |
| 4 | Oblong bars | 40a | First end |
| 5 | Cable opening | 40b | Second end |
| 6 | Entraining contour | 42 | Helical and/or screw-like |
| | (inside) | | structure |
| 7 | Circumferential edge | 42a | Clockwisehelical structure |
| | | 42b | Counter-clockwise helical |
| | | | structure |
| 10 | Spring element | 43 | Latching hook |
| 11a | Two-step first element | 44 | Entraining hook |
| 11b | of the spring element | | |
| 12 | Second end of the | 50 | Sealing element |
| | spring element | | |
| 13 | Edge | 51 | Opening |
| D | Diameter | 52 | Pressure lamellae |
| D1 | Minimum diameter | 53 | Sealing lamellae |
| D2 | Maximum diameter | | |
| 20 | Latching ring | | |
| 21 | Entraining contour | | |
| 22 | Recess | | |
| 23 | Oblong bar | | |
| 24 | Base ring | | |
| 25 | Contour | | |
| 30 | Cable outlet socket | | |
| 31 | Circumferential groove | | |
| 32 | Base area | | |
| 33 | Recesses | | |
| 34 | Latching contours | | |
| 35 | Boundary | | |
| 100 | Cable screw connection | 130 | Tension relief element |
| | | 130a | First end |
| 110 | Screw head | 130b | Second end |
| 111 | Recesses | 131 | Helical structure |
| 112 | Hexagon section | 132 | Thread |
| 113 | Thread | 133 | Axis of symmetry |
| 114 | Sealing ring | 134 | Fixation projection |
| 115 | Internal thread | | |
| | | 140 | Sealing element |
| 120 | Cable outlet socket | 141 | Opening |
| 121 | Thread | | |
| 122 | Stop | 150 | Intermediate screw connection |
| | | 151 | Hexagon section |
| | | 152 | Stop |
| | | 153 | Thread |
| | | 154 | Sealing ring |
| | | 155 | Thread |
| 200 | Cable screw connection | 230 | Tension relief element |
| | | 230a | First end |
| 210 | Screw head | 230b | Second end |
| 211 | Bar | 231 | |
| 212 | Groove | 232 | Latching springs |
| 213 | Recess | 233 | Fixation projections |
| 214 | | 234 | Fixation projections |
| 215 | | | |
| | | 240 | Sealing element |
| 220 | Cable outlet socket | 241 | |
| 221 | | | |
| | | 250 | Intermediate screw connection |
| 270 | Sealing ring | 251 | Latching contour |
| | | 251a | Diagonal area |
| 280 | Latching ring | 252 | Latching spring |
| 281 | Latching contour | 253 | Circumferential bar |
| 281a | Diagonal area | 254 | Recess |
| | | 260 | Annular sinuous spring |
| 300 | Cable screw connection | 330 | Tension relief element |
| | | 331 | Latching hook |
| 310 | Screw head | 332 | Contour |
| 311 | Clamping tooth | | |
| 312 | Groove | 340 | Sealing element |
| 313 | Lamella structure | 341 | Sealing element |
| 370 | Fixation sheath | 350 | Intermediate screw connection |
| 371 | Latching contours | 351 | Recess |
| 372 | Recess | 352 | Circumferential groove |
| 373 | Contour | 353 | Contour |
| 374 | Contour | 354 | Contour |

1. A cable screw connection (1, 10, 200, 300) for a plug-in connection housing, with
a cable outlet socket (30, 120, 220) being formed at the housing body and
with a tension relief element (40, 130, 230, 330) being provided which mechanically stabilizes the cable to be connected as soon as a terminal screw head (2, 110, 210, 310) is screwed thereto,
characterized in that
the tension relief element (40, 130, 230, 330) can be fixed in a torque-proof fashion inside the cable screw connection (1, 100, 20, 300) at a first end (40a, 130a, 230a, 330a), and
a second end (40b, 130b, 230b, 330b) of the tension relief element (40, 130, 230, 330) can be distorted by a rotary motion of the screw head (2, 110, 210, 310) in reference to the first end (40a, 130a, 230a, 330a).

2. A cable screw connection for a plug-in connection housing according to claim 1, characterized in that the tension relief element (130) comprises fixation projections (134, 234) at a second end (130b), which engage matching recesses (111, 213) of the screw head (110, 210).

3. A cable screw connection for a plug-in screw connection housing according to claim 1, characterized in that the tension relief element (130) comprises a circumferential thread (132) by which the tension relief element (130) can be screwed in and fixated in the cable outlet socket (120) or in an intermediate screw connection (150).

4. A cable screw connection for a plug-in connection housing according to claim 1, characterized in that the screw head (110) is screwed directly to the cable outlet socket (120) or to an intermediate screw connection (150).

5. A cable connection for a plug-in connection housing according to claim 1, characterized in that the intermediate screw connection (150) is connected to the cable outlet socket (120).

6. A cable screw connection for a plug-in connection housing according to claim 1, characterized in that the tension relief element (40, 130, 230, 330) comprises a helical structure (42, 131) between its first end (40a, 130a, 230a, 330a) and its second end (40b, 130b, 230b, 330b).

7. A cable screw connection for a plug-in connection housing according to claim 1, characterized in that by a relative distortion of the first end (40a, 130a, 230a, 330a) in reference to the second end (40b, 130b, 230b, 330b) the helical structure (42, 131) of the tension relief elements (40, 130, 230, 330) can be tightened about the cable jacket, allowing the cable to be connected becoming mechanically stabilized.

8. A cable screw connection for a plug-in connection housing according to claim 1, characterized in that
a circumferential stop (122) is formed inside the cable outlet socket (120), extending in the radial direction,
limiting the length of engagement of the tension relief element (130) in the cable relief socket (120).

9. A cable screw connection for a plug-in connection housing according to claim 1, characterized in that the screw head (110) and/or the intermediate screw connection (150) is/are provided with a circumferential sealing ring (114, 154) and this way protecting the plug-in connection housing from media penetrating, such as dust and water.

10. A cable screw connection for a plug-in connection housing according to claim 1, characterized in that a sealing element (50, 140, 240, 340) is provided which surrounds the jacket of the cable to be connected in a sealing fashion and this way protects the plug-in connection housing from the penetration of media, such as dust and water.

11. A cable screw connection for a plug-in connection housing according to claim 1, characterized in that the tension relief element (40, 130, 230, 330) comprises contours (41, 132, 233, 332) at a first end (40, 130, 230, 330), which can be inserted into recesses or boundaries (33, 52, 122, 254, 372) of the cable outlet socket (30, 120, 220) such that the tension relief element (40, 130, 230, 330) is fixed in a torque-proof fashion at its end (40a, 130a, 230a, 330a).

12. A cable screw connection for a plug-in connection housing according to claim 11, characterized in that the tension relief element (40) comprises latching hooks (43) at a second end (40b) pointing radially outward, which can engage allocated latching contours (34) of the cable outlet socket (30), by which the tension relief element (40) can be fixed in a torque-proof fashion in one rotary direction at the second end (40b).

13. A cable screw connection for the plug-in connection housing according to claim 11, characterized in that at the second end (40b) the tension relief element (40) comprises entraining hooks (44) axially pointing radially outwardly and the clamping sheath (20) comprises at the inside matching entraining contours (6) such that by a relative motion of the clamping sheath (2) in reference to the tension relief element (40) in a first direction the second end (40b) of the tension relief element can be moved in reference to the first end (40a), which is fixed in the cable outlet socket (30).

14. A cable screw connection for a plug-in connection housing according to claim 11, characterized in that the entraining hooks (44) of the clamping sheath (2) are formed such that in a relative motion of the clamping sheath (2) in reference to the tension relief element (40) in a second direction the entraining hooks (44) of the tension relief elements (40) can glide along the entraining hooks (44) of the clamping sheath (2).

15. A cable screw connection for a plug-in connection housing according to claim 1, characterized in that the tension relief element (40) comprises a first (42a) and a second (42b) helical structure, which are embodied in mutually opposite directions, i.e. clockwise and counter-clockwise.

16. A cable screw connection for a plug-in connection housing according to claim 11, characterized in that the sealing system (50) is embodied disk-shaped and comprises in the center a circular opening (51), with its diameter (Dd) being smaller than the diameter of a cable to be sealed.

17. A cable tension relief and sealing system according to claim 11, characterized in that the sealing system (50) comprises pressure lamellae (52) at one side, which essentially extend along the circular perimeter.

18. A cable tension relief and sealing system according to claim 11, characterized in that the sealing system (50) comprises at one side sealing lamellae (53) essentially extending concentrically about the opening (51).
